(19) United States
(12) Patent Application Publication
(10) Pub. No.: US 2017/0369654 A1
(43) Pub. Date: Dec. 28, 2017

(54) CURABLE RESIN COMPOSITION

(71) Applicants: Dow Global Technologies LLC, Midland, MI (US); Rohm and Haas Electronic Materials LLC, Marlborough, MA (US)

(72) Inventors: Joseph Kao, Framingham, MA (US); Weijun Zhou, Sugar Land, TX (US); Yusuke Matsuda, Shrewsbury, MA (US); Yuanqiao Rao, Berwyn, PA (US); Michael Mulzer, Marlborough, MA (US); Jieqian Zhang, Southborough, MA (US)

(21) Appl. No.: 15/602,196

(22) Filed: May 23, 2017

Related U.S. Application Data
(60) Provisional application No. 62/354,274, filed on Jun. 24, 2016.

(51) Int. Cl. C08G 77/04; C09D 7/12; C08K 3/20; C03C 17/00; C08G 77/18; C08F 2/04; C09D 7/14; C08K 3/22

(52) U.S. Cl. CPC C08G 77/04; C09D 7/14; C09D 7/1266; C08K 3/22; C03C 17/001; C08G 77/18; C08F 2/04; C08K 3/20

(57) ABSTRACT

A curable resin composition comprising: (a) 27 to 60 wt % of a liquid siloxane oligomer comprising polymerized units of formula R¹ₘR²ₙSi(OR³)₄₋ₘ₋ₙ, wherein R¹ is a C₅-C₂₀ aliphatic group comprising an oxirane ring fused to an alicyclic ring, R² is a C₁-C₂₀ alkyl, C₆-C₃₀ aryl group, or a C₅-C₂₀ aliphatic group having one or more heteroatoms, R³ is a C₁-C₄ alkyl group or a C₁-C₄ acyl group, m is 0.1 to 2.0 and n is 0 to 2.0; (b) 35 to 66 wt % non-porous nanoparticles of silica, a metal oxide, or a mixture thereof, having an average particle diameter from 5 to 50 nm; and (c) 0.5 to 7 wt % of a cationic photoinitiator.

### FIELD OF THE INVENTION

The present invention relates to liquid curable hard coating formulations which can be applied to plastic substrates for optical uses.

### BACKGROUND OF THE INVENTION

An optically clear hard polymeric coating is useful in flexible display devices. Conventional compositions for this purpose relied on either sol-gel chemistry or photo-curable cross-linked urethane acrylates. More recently, silanes and epoxy resins have been used to make clear coatings, e.g., U.S. Pat. No. 7,790,347. However, this reference does not disclose the compositions of the present invention.

### SUMMARY OF THE INVENTION

The present invention is directed to a curable resin composition comprising:

(a) 27 to 60 wt % of a liquid siloxane oligomer comprising polymerized units of formula R¹ₘR²ₙSi(OR³)₄₋ₘ₋ₙ, wherein R¹ is a C₅-C₂₀ aliphatic group comprising an oxirane ring fused to an alicyclic ring, R² is a C₁-C₂₀ alkyl, C₆-C₃₀ aryl group, or a C₅-C₂₀ aliphatic group having one or more heteroatoms, R³ is a C₁-C₄ alkyl group or C₁-C₄ acyl group, m is 0.1 to 2.0 and n is 0 to 2.0;
(b) 35 to 66 wt % non-porous nanoparticles of silica, a metal oxide, or a mixture thereof, the non-porous nanoparticles having an average particle diameter from 5 to 50 nm; and
(c) 0.5 to 7 wt % of a cationic photoinitiator.

### DETAILED DESCRIPTION OF THE INVENTION

All percentages are weight percentages (wt %) and all temperatures are in ° C., unless otherwise specified. All operations are performed at room temperature (20-25° C.) unless otherwise specified. A material is considered to be a liquid if it is in the liquid state at room temperature. Average particle diameter is an arithmetic mean determined by Scanning Electron Microscopy and a Zetasizer Nano Z system. Surface area is determined using a BET surface area analyzer and reported as the arithmetic average. Molecular weight distribution and polystyrene equivalent molecular weight were measured with Viscotek TDA 305 SEC system with OmiSEC 4.6 software. Agilent PLgel Mixed E column (2 in series, 5 μm particle size, 30 cm L×7.6 mm ID column) and tetrahydrofuran (THF) were used for separation and sample preparation (0.25 wt. %). Column temperature was set to 40° C. during analysis and flow rate at 0.7 ml/min. For calibration, Agilent EasiCal PS2 kit was used. A coating is optically transparent if it exhibits an average light transmittance of at least 80%, and preferably at least 85% over the wavelength range of 380-700 nm.

As used herein, the term “oligomer” refers to a molecule having from 3 to 200 polymerized monomer units, preferably at least 5, preferably at least 7; preferably no more than 175, preferably no more than 150. When the siloxane oligomer contains siloxane units which are not identical, m and n are molar average values. Preferably, the siloxane oligomer is a liquid.

Preferably, R¹ contains at least 6 carbon atoms; preferably no more than 15, preferably no more than 12, preferably no more than 10. Preferably, R¹ comprises an oxirane ring fused to an alicyclic ring having 5 or 6 carbon atoms, preferably six, preferably a cyclohexane ring. Preferably, R¹ contains no elements other than carbon, hydrogen and oxygen. Preferably, R¹ is an epoxycyclohexyl group linked to silicon by a —(CH₂)ⱼ— group, where j is from 1 to 6, preferably one to four. Preferably, when R² is alkyl it contains no more than 15 carbon atoms, preferably no more than 12, preferably no more than 10. Preferably, when R² is an aryl group it contains no more than 25 carbon atoms, preferably no more than 20, preferably no more than 16. The term “C₅-C₂₀ aliphatic group having one or more heteroatoms” refers to a C₅-C₂₀ aliphatic group having one or more of: a halogen such as fluorine; an ester group such as an acrylate group, a methacrylate group, a fumarate group, and a maleate group; a urethane group; and a vinyl ether group. It is preferred that R² is a C₁-C₂₀ alkyl or C₆-C₃₀ aryl group, and more preferably C₁-C₂₀ alkyl. In an alternate preferred embodiment, R² is a C₁-C₂₀ alkyl or a C₅-C₂₀ aliphatic group having one or more heteroatoms, and more preferably C₁-C₂₀ alkyl. Preferably, when R³ is alkyl, it is methyl or ethyl, preferably methyl. When R³ is acyl, it is preferably formyl or acetyl.

Preferably, m is at least 0.2, preferably at least 0.5; preferably no greater than 1.75, preferably no greater than 1.5. Preferably, n is no greater than 1.5, preferably no greater than 1.0, preferably no greater than 0.8, preferably zero.

Preferably, the resin composition comprises at least 28 wt % of the siloxane oligomer, preferably at least 29 wt %, preferably at least 30 wt %; preferably no more than 55 wt %, preferably no more than 53 wt %. Preferably, the resin composition comprises at least 40 wt % non-porous nanoparticles of silica, a metal oxide, or a mixture thereof, preferably at least 42; preferably no more than 65 wt %, preferably no more than 64 wt %, preferably no more than 63 wt %. The resin composition may contain polymerized units of silanes or epoxy silanes other than the siloxane oligomer described herein. The total amount of the siloxane oligomer plus any polymerized silanes or epoxy silanes is within the limits stated above. Preferably, the siloxane oligomer comprises at least 50 wt % of the total, preferably at least 75 wt %, preferably at least 90 wt %.

Preferably, the resin composition further comprises at least 1 wt % of the cationic photoinitiator (PI), preferably at least 1.5 wt %; preferably no more than 6 wt %, preferably no more than 5 wt %, preferably no more than 4.5 wt %. Preferred initiators include, e.g., diaryliodonium salts and triarylsulfonium salts.

Preferably, the non-porous nanoparticles are silica, zirconium oxide, or a mixture thereof, preferably silica. Preferably, the surface area of the non-porous nanoparticles is at least 50 m²/g, preferably at least 60 m²/g; preferably no greater than 500 m²/g, preferably no greater than 400 m²/g. Preferably, the average diameter of the nanoparticles is at least 10 nm, preferably at least 15 nm; preferably no greater than 40 nm, preferably no greater than 35 nm. Preferably, the nanoparticles are functionalized with substituent groups that can react with the epoxy group of epoxy-siloxane oligomer under a cationic photo curing process or thermal curing condition. Preferred substituent groups include, e.g., epoxy, acrylate, amino, vinyl ether, etc.

It will be appreciated that a mixture of nanoparticles may be used in the present curable resin compositions. One example of a mixture of nanoparticles is a mixture of two or more different kinds of nanoparticles such as a mixture of silica and zirconium oxide nanoparticles. Such mixture of nanoparticles may be a mixture of two or more different nanoparticles having the same or similar average diameter, such as a mixture of 20 nm silica and 20 nm zirconium oxide, or may be a mixture of two or more different nanoparticles having different average diameters, such as a mixture of 10 nm silica and 50 nm zirconium oxide. Another example of a mixture of nanoparticles is a mixture of two or more of the same nanoparticles but having different average diameters such as a mixture of first silica nanoparticles having an average diameter of 10 nm and second silica nanoparticles having an average diameter of 50 nm. When a mixture of silica and metal oxide nanoparticles are used in the present resin compositions, the total amount of the nanoparticles is from 35 to 66 wt %.

Optionally, the resin composition may further comprise one or more organic nanoparticles such as core-shell rubber (CSR) nanoparticles. The optional CSR nanoparticles comprise a rubber particle core and a shell layer, such CSR particles having an average diameter of from 50 to 250 nm. The shell layer of the CSR nanoparticles provides compatibility with the resin composition and has limited swellability to facilitate mixing and dispersion of the CSR nanoparticles in the resin composition. Suitable CSR nanoparticles are commercially available, such as those available under the following tradenames: Paraloid EXL 2650 A. EXL 2655, EXL2691 A, available from The Dow Chemical Company, or Kane Ace® MX series from Kaneka Corporation, such as MX 120, MX 125, MX 130, MX 136, MX 551, or METABLEN SX-006 available from Mitsubishi Rayon, or Genioperl P52 from Wacker Chemie AG. The CSR nanoparticles may be present in the curable composition in an amount ranging from 0 to 10 wt %, preferably in an amount of at least 0.1 wt %, preferably in an amount of up to 6 wt %, based on the total weight of the resin composition including the epoxy siloxane oligomer, the additives, and the cationic photoinitiator. Preferably, the resin composition further comprises one or more CSR nanoparticles, and more preferably a mixture of silica with one or more CSR nanoparticles or a mixture of zirconium oxide with one or more CSR nanoparticles.

Preferably, the resin composition further comprises a solvent. If a solvent is present, the amounts of the other components are calculated without including the solvent. Preferably, the solvent is a C₃-C₁₀ organic solvent comprising oxygen, preferably a C₃-C₁₀ ketone, ester, ether or a solvent having more than one of these functional groups. Preferably, the solvent is aliphatic. Preferably, the solvent molecule contains no more than eight carbon atoms, preferably no more than six. Preferably, the solvent molecule contains no atoms other than carbon, hydrogen and oxygen. Preferably, the solvent molecule contains no more than four oxygen atoms, preferably no more than three.

Optionally, reactive modifiers are added to the resin composition to modify the formulation for performance properties improvement. Such reactive modifiers include, without limitation, flexibility modifiers, hardness modifiers, viscosity modifiers, optical property modifiers, and the like. Preferably, the reactive modifiers are present in the resin composition in a total amount from 0 to 20 wt %; preferably at least 1 wt %, preferably at least 4 wt %, preferably at least 8 wt %; preferably no more than 17 wt %, preferably no more than 15 wt %. Preferably, the reactive modifier comprises at least two epoxycyclohexane groups or at least two oxetane rings, preferably two epoxycyclohexane groups. Preferred reactive modifiers are shown below, grouped according to the property usually improved by their use.

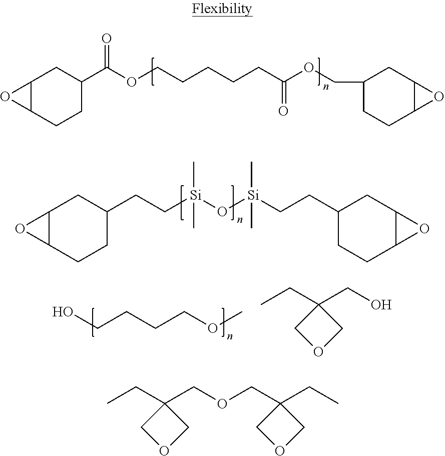

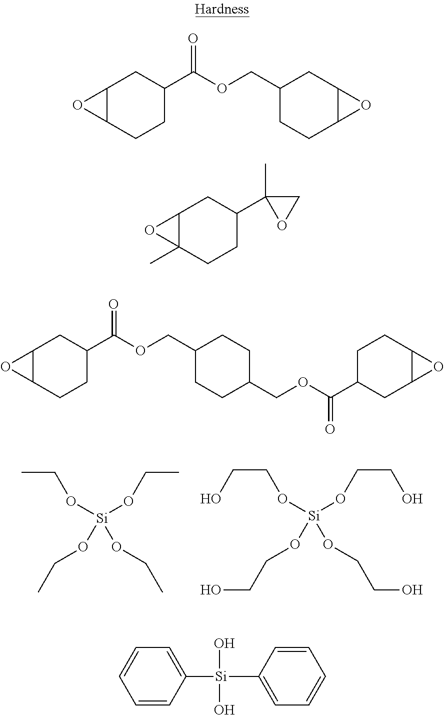

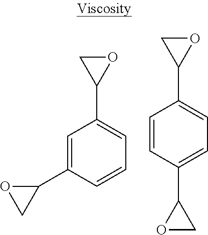

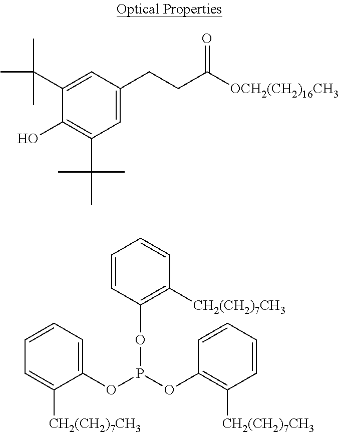

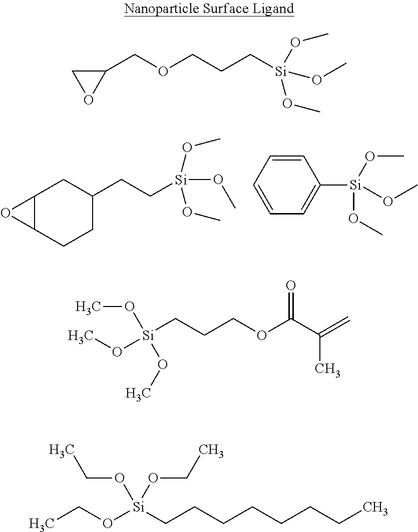

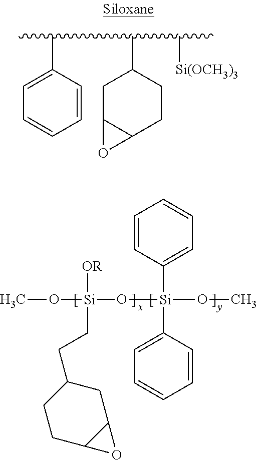

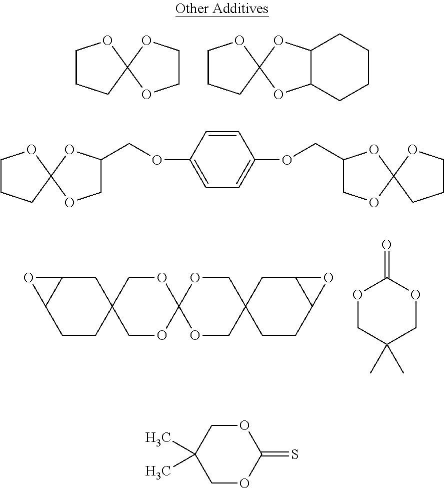

The present invention is further directed to a method for producing a clear polymeric coating by applying to a substrate a curable resin composition comprising: (a) 27 to 60 wt % of a liquid siloxane oligomer comprising polymerized units of formula R¹ₘR²ₙSi(OR³)₄₋ₘ₋ₙ, wherein R¹ is a C₅-C₂₀ aliphatic group comprising an oxirane ring fused to an alicyclic ring, R² is a C₅-C₂₀ alkyl, C₆-C₃₀ aryl group, or a C₅-C₂₀ aliphatic group having one or more heteroatoms, R³ is a C₁-C₄ alkyl group or a C₁-C₄ acyl group, m is 0.1 to 2.0 and n is 0 to 2.0; (b) 35 to 66 wt % non-porous nanoparticles of silica, a metal oxide, or a mixture thereof, the non-porous nanoparticles having an average particle diameter from 5 to 50 nm; and (c) 0.5 to 7 wt % of a cationic photoinitiator. Preferably, the resin composition is cured by exposure to ultraviolet light. Preferably, the substrate is a polymer film. Preferred polymer films include, e.g., PET, PC, PMMA, PEN, cyclic olefin polymers or cyclic olefin copolymers, aliphatic polyurethane, and polyimide.

Commonly known additives may be added to the resin composition to further modify properties of the cured coating, e.g., adhesion promoter, leveling agent, defoaming agent, anti-static agent, anti-blocking agent, UV absorber, optical whitening agent, etc. These additives may be in the liquid or solid form.

### EXAMPLES

| | Epoxy | | Reactive | | | | | | | | |
|---|---|---|---|---|---|---|---|---|---|---|---|
| | Siloxane | | Modifier | | Nanofiller | | | Cationic | | Pen. | |
| Ex. | type | wt % | type | wt % | type | D | wt % | PI, wt % | Th | Hard. | BR |
| 1 | PC- | 50.3 | — | 0 | SiO₂ | 25 | 46.6 | 3.1 | 58 | 6H | 1.5 |
| | 2003 | | | | | | | | 81 | 8H | 2.4 |
| 2 | PC- | 43.7 | — | 0 | SiO₂ | 25 | 53.2 | 3.1 | 57 | 8H | 1.5 |
| | 2003 | | | | | | | | 78 | 9H | 2.4 |
| 3 | PC- | 36.9 | — | 0 | SiO₂ | 25 | 60.0 | 3.1 | 54 | 7H | 2.4 |
| | 2003 | | | | | | | | 87 | 9H | 4.8 |
| 4 | PC- | 33.0 | — | 0 | SiO₂ | 25 | 63.9 | 3.1 | 58 | 5H | 2.4 |
| | 2003 | | | | | | | | 80 | 7H | 4.8 |
| 5 | PC- | 40.6 | — | 0 | ZrO₂ | 5 | 56.5 | 2.9 | 49 | 6H | 1.5 |
| | 2003 | | | | | | | | | | |
| 6 | PC- | 40.6 | — | 0 | ZrO₂ | 5 | 14.1 | 2.9 | 55 | 7H | 1.5 |
| | 2003 | | | | SiO₂ | 25 | 42.4 | | | | |
| 7 | PC- | 30.6 | Add | 13.1 | SiO₂ | 25 | 53.2 | 3.1 | 75 | 8H | 2.4 |
| | 2003 | | .1 | | | | | | | | |
| 8 | PC- | 30.6 | Add | 13.1 | SiO₂ | 25 | 53.2 | 3.1 | 50 | 5H | 1.0 |
| | 2003 | | .2 | | | | | | | | |
| 9 | ECSiO | 43.7 | — | 0 | SiO₂ | 25 | 53.2 | 3.1 | 77 | 8H | 2.4 |
| 10 | PC- | 30.4 | — | 0 | SiO₂ | 25 | 53.6 | 3.0 | 77 | 8H | 2.4 |
| | 2003 | | | | | | | | | | |
| | ECSiO | 13.0 | | | | | | | | | |
| 11 | PC- | 59.4 | — | 0 | SiO₂ | 25 | 39.6 | 1.0 | 52 | 6H | 1.0 |
| | 2000HV | | | | | | | | | | |
| 12 | PC- | 54.5 | — | 0 | SiO₂ | 25 | 44.5 | 1.0 | 52 | 7H | 1.0 |
| | 2000HV | | | | | | | | | | |
| 13 | PC- | 49.5 | — | 0 | SiO₂ | 25 | 49.5 | 1.0 | 54 | 8H | 1.0 |
| | 2000HV | | | | | | | | | | |
| 14 | PC- | 39.6 | — | 0 | SiO₂ | 25 | 59.4 | 1.0 | 58 | 7H | 1.0 |
| | 2000HV | | | | | | | | | | |
| 15 | PC- | 48.3 | Add | 2.0 | SiO₂ | 25 | 48.3 | 0.9 | 60 | 8H | 1.0 |
| | 2000HV | | .1 | | CSR | 150 | 0.5 | | | | |
| 16 | PC- | 46.0 | Add | 5.5 | SiO₂ | 25 | 46.0 | 1.0 | 48 | 8H | 1.0 |
| | 2000HV | | .1 | | CSR | 150 | 1.5 | | | | |
| 17 | PC- | 49.5 | — | 0 | SiO₂ | 10 | 12.4 | 1 | 50 | 8H | 1.0 |
| | 2000HV | | | | | 50 | 37.1 | | | | |
| C1 | PC- | 97.0 | — | 0 | SiO₂ | 25 | 0.0 | 3.0 | 53 | 3H | 1.0 |
| | 2003 | | | | | | | | 80 | 4H | 1.0 |
| C2 | ECSiO | 97.0 | — | 0 | SiO₂ | 25 | 0.0 | 3.0 | 56 | 4H | 1.0 |
| | | | | | | | | | 78 | 5H | 1.0 |
| C3 | GCSiO | 97.0 | — | 0 | SiO₂ | 25 | 0.0 | 3.0 | 52 | 6B | 1.0 |
| | | | | | | | | | 76 | 6B | 1.0 |
| C4 | GCSiO | 43.3 | — | 0 | SiO₂ | 25 | 53.6 | 3.1 | 51 | 6B | 1.0 |
| | | | | | | | | | 72 | 6B | 1.0 |
| C5 | PC- | 99.0 | — | 0 | SiO₂ | 25 | 0.0 | 1.0 | 50 | 4H | 1.0 |
| | 2000HV | | | | | | | | | | |
| C6 | PC- | 73.5 | — | 0 | SiO₂ | 25 | 23.6 | 2.9 | 80 | 4H | 1.0 |
| | 2003 | | | | | | | | 88 | 5H | 2.4 |
| C7 | PC- | 74.2 | — | 0 | SiO₂ | 25 | 24.8 | 1.0 | 62 | 5H | 1.0 |
| | 2000HV | | | | | | | | | | |
| C8 | PC- | 66.7 | — | 0 | SiO₂ | 25 | 30.3 | 3.0 | 54 | 4H | 1.0 |
| | 2003 | | | | | | | | 75 | 5H | 2.0 |
| C9 | PC- | 29.0 | — | 0 | SiO₂ | 25 | 67.8 | 3.2 | 55 | 4H | 1.0 |
| | 2003 | | | | | | | | | | |
| C10 | PC- | 24.8 | — | 0 | SiO₂ | 25 | 74.2 | 1.0 | 54 | 5H | 1.0 |
| | 2000HV | | | | | | | | | | |
| C11 | PC- | 13.1 | Add | 30.6 | SiO₂ | 25 | 53.2 | 3.1 | 52 | 3H | 1.0 |
| | 2003 | | .1 | | | | | | | | |
| C12 | PC- | 40.6 | — | 0 | POSS | <1 | 56.5 | 2.9 | 62 | 3H | 1.0 |
| | 2003 | | | | | | | | | | |

Th = thickness in μm.
Pen. Hard. = pencil hardness.
BR = bending radius in mm, measured as the minimum radius to which the film may be bent inward without causing defects in the coating. The measurements were conducted using a manual TQC Cylindrical Bend Tester following ISO 1519 standards.
D = average particle diameter in nm.

### Note:

(i) PC-2003: Mw=1415 g/mol, Mn=975 g/mol; ECSiO: Mw=1482 g/mol, Mn=1300 g/mol; GCSiO: Mw=2436 g/mol, Mn=2100 g/mol; PC-2000HV: Mw=5400 g/mol, Mn=2755 g/mol. The molecular weights of the epoxy siloxane oligomers were characterized using a gel permeation chromatography (GPC) with Agilent PLgel GPC columns and polystyrene as the standard.
(i) Additive 1: 3,4-Epoxycyclohexylmethyl 3,4-epoxycyclohexanecarboxylate
(ii) Additive 2: 3,3′-(Oxybis(methylene))bis(3-ethyloxetane)

For commercial purposes, it is important to have a balance of high hardness and high flexibility (low BR, typically no greater than 5). The examples in the present application unexpectedly improve hardness without an unacceptable adverse effect on flexibility, as opposed to the comparative examples, which are outside of one or more of the claim limits.

### Comparative Example 1: Epoxy Siloxane Nanocomposite Formulation C1

A formulation consisting of the components listed in the table was prepared. 2.47 g of an epoxy siloxane oligomer (PC-2003 from Polyset Co. Inc.) was mixed with 2.77 g of the nanoparticle solution (80 wt % ˜25 nm solid spherical SiO₂ nanoparticles and 20 wt % methyl ethyl ketone) obtained from Admatechs (YA025C-MFK). The solution was sonicated repeatedly to ensure homogeneous mixing. After sonication, 0.15 g of the triarylsulfonium hexafluoroantimonate salts (50 wt % solution in propylene carbonate) was added into the solution and mixed using Vortex. Two films with thicknesses around 56 and 88 μm were prepared on 50 μm Melinex® 462 PET using 6 mil (152 μm) and 8 mil (203 μm) draw-down blades. Next, the films were UV cured 3 times at 30 fpm, 30 fpm, and 10 fpm (“fpm” is line speed in ft/min in at least one place), respectively, using a Fusion 300 UV conveyor system. After UV curing, the films were thermally annealed at 85° C. for two hours in a Lindberg Blue M oven. The pencil hardness of the films was measured using a Qualtech Product Industry Manual Pencil Hardness Tester following ASTM D3363 standards at 1.5 kgf vertical load on a 0.5 cm thick glass plate.

### Example 1: Epoxy Siloxane Nanocomposite Formulation

A formulation consisting of the components listed in the table was prepared. 2.43 g of an epoxy siloxane oligomer (PC-2003 from Polyset Co. Inc.) was mixed with 3.22 g of the nanoparticle solution (70 wt % ˜25 nm solid spherical SiO₂ nanoparticles and 30 wt % methyl ethyl ketone) obtained from Admatechs (YA025C-MFK). The solution was sonicated repeatedly to ensure homogeneous mixing. After sonication, 0.15 g of the triarylsulfonium hexafluoroantimonate salts was added into the solution and mixed using Vortex. Two films with thicknesses around 46 and 85 μm were prepared on 50 μm Melinex® 462 PET using 6 mil (152 μm) and 8 mil (203 μm) draw-down blades. Next, the films were UV cured 3 times at 30 fpm, 30 fpm, and 10 fpm, respectively, using a Fusion 300 UV conveyor system. After UV curing, the films were thermally annealed at 85° C. for two hours in a Lindberg Blue M oven. The pencil hardness of the films was measured using a Qualtech Product Industry Manual Pencil Hardness Tester following ASTM D3363 standards at 1.5 kgf vertical load on a 0.5 cm thick glass plate.

### Example 2: Epoxy Siloxane Nanocomposite Formulation

A formulation consisting of the components listed in the table was prepared. 4.18 g of an epoxy siloxane oligomer (PC-2003 from Polyset Co. Inc.) was mixed with 7.28 g of the nanoparticle solution (70 wt % ˜25 nm solid spherical SiO₂ nanoparticles and 30 wt % methyl ethyl ketone) obtained from Admatechs (YA025C-MFK). The solution was sonicated repeatedly to ensure homogeneous mixing. After sonication, 0.3 g of the triarylsulfonium hexafluoroantimonate salts was added into the solution and mixed using Vortex. Two films with thicknesses around 57 and 78 μm were prepared on 50 μm Melinex® 462 PET using 6 mil (152 μm) and 8 mil (203 μm) draw-down blades. Next, the films were UV cured and characterized following the same procedures described in Example 1.

### Example 3: Epoxy Siloxane Nanocomposite Formulation

A formulation consisting of the components listed in the table was prepared. 3.50 g of an epoxy siloxane oligomer (PC-2003 from Polyset Co. Inc.) was mixed with 8.13 g of the nanoparticle solution (70 wt % ˜25 nm solid spherical SiO₂ nanoparticles and 30 wt % methyl ethyl ketone) obtained from Admatechs (YA025C-MFK). The solution was sonicated repeatedly to ensure homogeneous mixing. After sonication, 0.3 g of the triarylsulfonium hexafluoroantimonate salts was added into the solution and mixed using Vortex. Two films with thicknesses around 54 and 87 μm were prepared on 50 μm Melinex® 462 PET using 6 mil (152 μm) and 8 mil (203 μm) draw-down blades. Next, the films were UV cured and characterized following the same procedures described in Example 1.

### Example 4: Epoxy Siloxane Nanocomposite Formulation

A formulation consisting of the components listed in the table was prepared. 3.11 g of an epoxy siloxane oligomer (PC-2003 from Polyset Co. Inc.) was mixed with 8.64 g of the nanoparticle solution (70 wt % ˜25 nm solid spherical SiO₂ nanoparticles and 30 wt % methyl ethyl ketone) obtained from Admatechs (YA025C-MFK). The solution was sonicated repeatedly to ensure homogeneous mixing. After sonication, 0.3 g of the triarylsulfonium hexafluoroantimonate salts was added into the solution and mixed using Vortex. Two films with thicknesses around 58 and 80 μm were prepared on 50 μm Melinex® 462 PET using 6 mil (152 μm) and 8 mil (203 μm) draw-down blades. Next, the films were UV cured and characterized following the same procedures described in Example 1.

### Example 5: Epoxy Siloxane Nanocomposite Formulation

A formulation consisting of the components listed in the table was prepared. 4.18 g of an epoxy siloxane oligomer (PC-2003 from Polyset Co. Inc.) was mixed with 11.64 g of the nanoparticle solution (50 wt % ˜5 nm solid spherical ZO₂ nanoparticles and 50 wt % PGMEA) obtained from Pixelligent (PCPG). The solution was sonicated repeatedly to ensure homogeneous mixing. After sonication, 0.3 g of the triarylsulfonium hexafluoroantimonate salts was added into the solution and mixed using Vortex. A ˜50-60 μm thick film was prepared on a 50 μm Melinex® 462 PET using a 8 mil (203 μm) draw-down blade. Next, the film was UV cured and characterized following the same procedures described in Example 1.

### Example 6: Epoxy Siloxane Nanocomposite Formulation

A formulation consisting of the components listed in the table was prepared. 4.18 g of an epoxy siloxane oligomer (PC-2003 from Polyset Co. Inc.) was mixed with 2.9 g of the nanoparticle solution (50 wt % ˜5 nm solid spherical ZrO₂ nanoparticles and 50 wt % PGMEA) obtained from Pixelligent (PCPG). 4.37 g of the SiO2 nanoparticles was obtained by drying the YAO25C-MFK nanoparticle solution from Admatechs using Rotovap. The dried SiO2 nanoparticles were then added into the solution and sonicated repeatedly to ensure homogeneous mixing. After sonication, 0.3 g of the triarylsulfonium hexafluoroantimonate salts was added into the solution and mixed using Vortex. A ˜50-60 μm was prepared on a 50 μm Melinex® 462 PET using a 8 mil (203 μm) draw-down blade. Next, the film was UV cured and characterized following the same procedures described in Example 1.

### Example 7: Epoxy Siloxane Nanocomposite Formulation

A formulation consisting of the components listed in the table was prepared. 2.93 g of an epoxy siloxane oligomer (PC-2003 from Polyset Co. Inc.) was mixed with 1.25 g of 3,4-epoxycyclohexylmethyl 3,4-epoxycyclohexanecarboxylate (Sigma Aldrich) and 7.28 g of the nanoparticle solution (70 wt % ˜25 nm solid spherical SiO₂ nanoparticles and 30 wt % methyl ethyl ketone from Admatechs, YAO25C-MFK). The solution was sonicated repeatedly to ensure homogeneous mixing. After sonication, 0.3 g of the triarylsulfonium hexafluoroantimonate salts was added into the solution and mixed using Vortex. A ˜75 μm thick film was prepared on a 50 μm MELINEX® 462 PET using a 8 mil (203 μm) draw-down blade. Next, the film was UV cured and characterized following the same procedures described in Example 1.

### Example 8: Epoxy Siloxane Nanocomposite Formulation

A formulation consisting of the components listed in the table was prepared. 2.93 g of an epoxy siloxane oligomer (PC-2003 from Polyset Co. Inc.) was mixed with 1.25 g of 3,3′-(oxybis(methylene))bis(3-ethyloxetane) (Sigma Aldrich) and 7.28 g of the nanoparticle solution (70 wt % ˜25 nm solid spherical SiO₂ nanoparticles and 30 wt % methyl ethyl ketone from Admatechs, YA025C-MFK). The solution was sonicated repeatedly to ensure homogeneous mixing. After sonication, 0.3 g of the triarylsulfonium hexafluoroantimonate salts was added into the solution and mixed using Vortex. A 50 μm thick film was prepared on a 50 μm Melinex® 462 PET using a 8 mil (203 μm) draw-down blade. Next, the film was UV cured and characterized following the same procedures described in Example 1.

### Example 9: Epoxy Siloxane Nanocomposite Formulation

The epoxy siloxane oligomer (ECSiO) was synthesized based on a conventional sol-gel chemistry procedure. 2-(3,4-Epoxycyclohexyl)ethyltrimethoxysilane (ECTMS, Gelest) and water (H₂O, Sigma-Aldrich) were mixed at a ratio of 24.64 g:2.70 g (0.1 mol:0.15 mol) in an 100 mL 2-neck flask. Thereafter, 0.05 mL ammonia was added to the mixture, and stirred at 60° C. for 6 hours. The mixture was filtered using a 0.45 μm Teflon filter, thereby obtaining an alicyclic epoxy siloxane resin. The molecular weight of the alicyclic epoxy siloxane resin was measured using GPC. The alicyclic epoxy siloxane resin is denoted as ECSiO and has a number average molecular weight of 1300, a weight-average molecular weight of 1482, and a PDI (Mw/Mn) of 1.14.

Next, 4.18 g of the synthesized epoxy siloxane oligomer was mixed with 7.28 g of the nanoparticle solution (70 wt % ˜25 nm solid spherical SiO₂ nanoparticles and 30 wt % methyl ethyl ketone from Admatechs, YA025C-MFK). The solution was sonicated repeatedly to ensure homogeneous mixing. After sonication, 0.3 g of the triarylsulfonium hexafluoroantimonate salts was added into the solution and mixed using Vortex. A ˜77 μm thick film was prepared on a 50 μm Melinex® 462 PET using a 8 mil (203 μm) draw-down blade. Next, the film was UV cured and characterized following the same procedures described in Example 1.

### Example 10: Epoxy Siloxane Nanocomposite Formulation

The epoxy siloxane oligomer (ECSiO) was synthesized based on a conventional sol-gel chemistry procedure specified in Example 9. 1.25 g of the synthesized ECSiO epoxy siloxane oligomer was mixed with 2.93 g of the PC-2003 epoxy siloxane oligomer and 7.38 g of the nanoparticle solution (70 wt % ˜25 nm solid spherical SiO2 nanoparticles and 30 wt % methyl ethyl ketone from Admatechs, YA025C-MFK). The solution was sonicated repeatedly to ensure homogeneous mixing. After sonication, 0.3 g of the triarylsulfonium hexafluoroantimonate salts was added into the solution and mixed using Vortex. A ˜77 μm thick film was prepared on a 50 μm Melinex® 462 PET using a 8 mil (203 μm) draw-down blade. Next, the film was UV cured and characterized following the same procedures described in Example 1.

### Example 11: Epoxy Siloxane Nanocomposite Formulation

An epoxy siloxane oligomer (5.94 g)(PC-2000HV from Polyset Co. Inc.) was mixed with 7.92 g of the nanoparticle solution (50 wt % ˜25 nm solid spherical SiO₂ nanoparticles and 50 wt % methyl isobutyl ketone) obtained from Admatechs (25nmSE-AK1). The solution was sonicated repeatedly to ensure homogeneous mixing. After sonication, the solution was concentrated through rotary evaporation to yield a solution containing ˜20 wt % methyl isobutyl ketone. Lastly, 0.10 g of the triarylsulfonium hexafluoroantimonate salts was added into the solution and mixed using Vortex. A 52 μm thick film was prepared on 50 μm Melinex® 462 PET using a 5 mil (127 μm) draw-down blade. Next, the film was UV cured and characterized following the same procedures described in Example 1.

### Example 12: Epoxy Siloxane Nanocomposite Formulation

An epoxy siloxane oligomer (5.45 g) (PC-2000HV from Polyset Co. Inc.) was mixed with 8.90 g of the nanoparticle solution (50 wt % ˜25 nm solid spherical SiO₂ nanoparticles and 50 wt % methyl isobutyl ketone) obtained from Admatechs (25nmSE-AK1). The solution was sonicated repeatedly to ensure homogeneous mixing. After sonication, the solution was concentrated through rotary evaporation to yield a solution containing ˜20 wt % methyl isobutyl ketone. Lastly, 0.10 g of the triarylsulfonium hexafluoroantimonate salts was added into the solution and mixed using Vortex. A 52 μm thick film was prepared on 50 μm Melinex® 462 PET using a 5 mil (127 μm) draw-down blade. Next, the film was UV cured and characterized following the same procedures described in Example 1.

### Example 13: Epoxy Siloxane Nanocomposite Formulation

An epoxy siloxane oligomer (4.95 g) (PC-2000HV from Polyset Co. Inc.) was mixed with 9.90 g of the nanoparticle solution (50 wt % ˜25 nm solid spherical SiO₂ nanoparticles and 50 wt % methyl isobutyl ketone) obtained from Admatechs (25nmSE-AK1). The solution was sonicated repeatedly to ensure homogeneous mixing. After sonication, the solution was concentrated through rotary evaporation to yield a solution containing ˜20 wt % methyl isobutyl ketone. Lastly, 0.10 g of the triarylsulfonium hexafluoroantimonate salts was added into the solution and mixed using Vortex. A 54 μm thick film was prepared on 50 μm Melinex® 462 PET using a 5 mil (127 μm) draw-down blade. Next, the film was UV cured and characterized following the same procedures described in Example 1.

### Example 14: Epoxy Siloxane Nanocomposite Formulation

An epoxy siloxane oligomer (3.96 g) (PC-2000HV from Polyset Co. Inc.) was mixed with 11.88 g of the nanoparticle solution (50 wt % ˜25 nm solid spherical SiO₂ nanoparticles and 50 wt % methyl isobutyl ketone) obtained from Admatechs (25nmSE-AK1). The solution was sonicated repeatedly to ensure homogeneous mixing. After sonication, the solution was concentrated through rotary evaporation to yield a solution containing ˜20 wt % methyl isobutyl ketone. Lastly, 0.10 g of the triarylsulfonium hexafluoroantimonate salts was added into the solution and mixed using Vortex. A 58 μm thick film was prepared on 50 μm Melinex® 462 PET using a 5 mil (127 μm) draw-down blade. Next, the film was UV cured and characterized following the same procedures described in Example 1.

### Example 15: Epoxy Siloxane Nanocomposite Formulation

An epoxy siloxane oligomer (4.83 g) (PC-2000HV from Polyset Co. Inc.) was mixed with 0.25 g of MX 551 (75 wt % 3,4-epoxycyclohexylmethyl-3,4-epoxycyclohexanecarboxylate; 25 wt % ˜100 nm styrene-butadiene core-shell rubber nanoparticle) from Kaneka and 9.66 g of the 25nmSE-AK1 nanoparticle solution (50 wt % ˜25 nm solid spherical SiO₂ nanoparticles and 50 wt % methyl isobutyl ketone) from Admatechs. The solution was sonicated repeatedly to ensure homogeneous mixing. After sonication, the solution was dried through rotary evaporation at room temperature for 2 hours. Once dried, the resin was redispersed in 1.50 g of toluene (from Sigma Aldrich) and 1.50 g of 2, 4-dimethyl-3-pentanone (from Oakwood Chemical). Lastly, 0.09 g of the triarylsulfonium hexafluoroantimonate salts was added into the solution and mixed using Vortex. A 60 μm thick film was prepared on 50 μm Melinex® 462 PET using a 5 mil (127 μm) draw-down blade. Next, the film was UV cured and characterized following the same procedures described in Example 1.

### Example 16: Epoxy Siloxane Nanocomposite Formulation

An epoxy siloxane oligomer (4.60 g) (PC-2000HV from Polyset Co. Inc.) was mixed with 0.69 g of MX 551 (75 wt % 3,4-epoxycyclohexylmethyl-3,4-epoxycyclohexanecarboxylate; 25 wt % ˜100 nm styrene-butadiene core-shell rubber nanoparticle) from Kaneka and 9.20 g of the 25nmSE-AK1 nanoparticle solution (50 wt % ˜25 nm solid spherical SiO₂ nanoparticles and 50 wt % methyl isobutyl ketone) from Admatechs. The solution was sonicated repeatedly to ensure homogeneous mixing. After sonication, the solution was dried through rotary evaporation at room temperature for 2 hours. Once dried, the resin was redispersed in 1.50 g of toluene (from Sigma Aldrich) and 1.50 g of 2, 4-dimethyl-3-pentanone (from Oakwood Chemical). Lastly, 0.11 g of the triarylsulfonium hexafluoroantimonate salts was added into the solution and mixed using Vortex. A 48 μm thick film was prepared on 50 μm Melinex® 462 PET using a 5 mil (127 μm) draw-down blade. Next, the film was UV cured and characterized following the same procedures described in Example 1.

### Example 17: Epoxy Siloxane Nanocomposite Formulation

An epoxy siloxane oligomer (4.95 g) (PC-2000HV from Polyset Co. Inc.) was mixed with 2.48 g of the 10nmSE-AK1 nanoparticle solution (50 wt % ˜10 nm solid spherical SiO₂ nanoparticles and 50 wt % methyl isobutyl ketone) and 7.42 g of the 50nmSE-AK1 nanoparticle solution (50 wt % ˜50 nm solid spherical SiO₂ nanoparticles and 50 wt % methyl isobutyl ketone) from Admatechs. The solution was sonicated repeatedly to ensure homogeneous mixing. After sonication, the solution was concentrated through rotary evaporation to yield a solution containing ˜20 wt % methyl isobutyl ketone. Lastly, 0.10 g of the triarylsulfonium hexafluoroantimonate salts was added into the solution and mixed using Vortex. A 50 μm thick film was prepared on 50 μm Melinex® 462 PET using a 5 mil (127 μm) draw-down blade. Next, the film was UV cured and characterized following the same procedures described in Example 1.

### Comparative Example 2: Epoxy Siloxane Formulation

9.70 g of the PC-2003 epoxy siloxane oligomer (Polyset Co. Inc.) was mixed with 3.5 g of methyl ethyl ketone by sonication. After sonication, 0.3 g of the triarylsulfonium hexafluoroantimonate salts was added into the solution and mixed using Vortex. Two films with thicknesses around 53 and 80 μm were prepared on 50 μm Melinex® 462 PET using 6 mil (152 μm) and 8 mil (203 μm) draw-down blades. Next, the films were UV cured and characterized following the same procedures described in Example 1.

### Comparative Example 3: Epoxy Siloxane Nanocomposite Formulation

2.72 g of the PC-2003 epoxy siloxane oligomer (Polyset Co. Inc.) was mixed with 9.10 g of the nanoparticle solution (70 wt % ˜25 nm solid spherical SiO₂ nanoparticles and 30 wt % methyl ethyl ketone) obtained from Admatechs (YA025C-MFK). The solution was sonicated repeatedly to ensure homogeneous mixing. After sonication, 0.3 g of the triarylsulfonium hexafluoroantimonate salts was added into the solution and mixed using Vortex. A ˜55 μm thick film was prepared on a 50 μm Melinex® 462 PET using a 8 mil (203 μm) draw-down blade. Next, the film was UV cured and characterized following the same procedures described in Example 1.

### Comparative Example 4: Epoxy Siloxane Formulation

The epoxy siloxane oligomer (ECSiO) was synthesized based on a conventional sol-gel chemistry procedure specified in Example 9. 9.70 g of ECSiO epoxy siloxane oligomer was mixed with 2.0 g of methyl ethyl ketone by sonication. After sonication, 0.3 g of the triarylsulfonium hexafluoroantimonate salts was added into the solution and mixed using Vortex. Two films with thicknesses around 56 and 78 μm were prepared on 50 μm Melinex® 462 PET using 6 mil (152 μm) and 8 mil (203 μm) draw-down blades. Next, the films were UV cured and characterized following the same procedures described in Example 1.

### Comparative Example 5: Epoxy Siloxane Formulation

The epoxy siloxane oligomer (GCSiO) was synthesized based on the conventional sol-gel chemistry procedures. 3-glycidoxypropyltrimethoxysilane (GPTS, the Gelest company) and water (H₂O, the Sigma-Aldrich company) were mixed at a ratio of 23.63 g:2.70 g (0.1 mol:0.15 mol) and injected in a 100 mL 2-neck flask. Thereafter, 0.05 mL ammonia was added to the mixture as a catalyst and stirred at 60° C. for 6 hours The mixture was filtered using a 0.45 μm Teflon filter, thereby obtaining an alicyclic epoxy siloxane resin. The molecular weight of the alicyclic epoxy siloxane resin was measured using GPC. The alicyclic epoxy siloxane resin is denoted as GCSiO and has a number average molecular weight of 2100, a weight-average molecular weight of 2436, and a PDI (Mw/Mn) of 1.16.

Next, 9.70 g of the synthesized epoxy siloxane oligomer was mixed with 2.0 g of methyl ethyl ketone by sonication. After sonication, 0.3 g of the triarylsulfonium hexafluoroantimonate salts was added into the solution and mixed using Vortex. Two films with thicknesses around 56 and 78 μm were prepared on 50 μm Melinex® 462 PET using 6 mil (152 μm) and 8 mil (203 μm) draw-down blades. Next, the films were UV cured and characterized following the same procedures described in Example 1.

### Comparative Example 6: Epoxy Siloxane Nanocomposite Formulation

The epoxy siloxane oligomer (ECSiO) was synthesized based on a conventional sol-gel chemistry procedure specified in Comparative Example 5.

Next, 4.18 g of the synthesized epoxy siloxane oligomer was mixed with 7.38 g of the nanoparticle solution (70 wt % ˜25 nm solid spherical SiO₂ nanoparticles and 30 wt % methyl ethyl ketone from Admatechs, YA025C-MFK). The solution was sonicated repeatedly to ensure homogeneous mixing. After sonication, 0.3 g of the triarylsulfonium hexafluoroantimonate salts was added into the solution and mixed using Vortex. Two films with thicknesses around 51 and 72 μm were prepared on 50 μm Melinex® 462 PET using 6 mil (152 μm) and 8 mil (203 μm) draw-down blades. Next, the films were UV cured and characterized following the same procedures described in Example 1.

### Comparative Example 7: Epoxy Siloxane Nanocomposite Formulation

A formulation consisting of the components listed in the table was prepared. 1.25 g of an epoxy siloxane oligomer (PC-2003 from Polyset Co. Inc.) was mixed with 2.93 g of 3,4-Epoxycyclohexylmethyl 3,4-epoxycyclohexanecarboxylate (Sigma Aldrich) and 7.28 g of the nanoparticle solution (70 wt % ˜25 nm solid spherical SiO₂ nanoparticles and 30 wt % methyl ethyl ketone from Admatechs, YA025C-MFK). The solution was sonicated repeatedly to ensure homogeneous mixing. After sonication, 0.3 g of the triarylsulfonium hexafluoroantimonate salts was added into the solution and mixed using Vortex. A ˜52 μm thick film was prepared on a 50 μm Melinex® 462 PET using a 8 mil (203 μm) draw-down blade. Next, the film was UV cured and characterized following the same procedures described in Example 1.

### Comparative Example 8: Epoxy Siloxane Nanocomposite Formulation

A formulation consisting of the components listed in the table was prepared. 4.18 g of an epoxy siloxane oligomer (PC-2003 from Polyset Co. Inc.) was mixed with 5.82 g of octaepoxycyclohexyldimethylsilyl POSS (EP0430 from Hybrid Plastics) and 4.0 g of methyl ethyl ketone. The solution was sonicated repeatedly to ensure homogeneous mixing. After sonication, 0.3 g of the triarylsulfonium hexafluoroantimonate salts was added into the solution and mixed using Vortex. A ˜52 μm thick film was prepared on a 50 μm Melinex® 462 PET using a 8 mil (203 μm) draw-down blade. Next, the film was UV cured and characterized following the same procedures described in Example 1.

### Comparative Example 9: Epoxy Siloxane Nanocomposite Formulation

A formulation consisting of the components listed in the table was prepared. 6.67 g of an epoxy siloxane oligomer (PC-2003 from Polyset Co. Inc.) was mixed with 4.33 g of the nanoparticle solution (70 wt % ˜25 nm solid spherical SiO₂ nanoparticles and 30 wt % methyl ethyl ketone) obtained from Admatechs (YA025C-MFK). The solution was sonicated repeatedly to ensure homogeneous mixing. After sonication, 0.3 g of the triarylsulfonium hexafluoroantimonate salts was added into the solution and mixed using Vortex. Two films with thicknesses around 54 and 87 μm were prepared on 50 μm Melinex® 462 PET using 6 mil (152 μm) and 8 mil (203 μm) draw-down blades. Next, the films were UV cured and characterized following the same procedures described in Example 1.

### Comparative Example 10: Epoxy Siloxane Nanocomposite Formulation

An epoxy siloxane oligomer (2.48 g) (PC-2000HV from Polyset Co. Inc.) was mixed with 14.84 g of the nanoparticle solution (50 wt % ˜25 nm solid spherical SiO₂ nanoparticles and 50 wt % methyl isobutyl ketone) obtained from Admatechs (25nmSE-AK1). The solution was sonicated repeatedly to ensure homogeneous mixing. After sonication, the solution was concentrated through rotary evaporation to yield a solution containing ˜20 wt % methyl isobutyl ketone. Lastly, 0.10 g of the triarylsulfonium hexafluoroantimonate salts was added into the solution and mixed using Vortex. A 62 μm thick film was prepared on 50 μm Melinex® 462 PET using a 5 mil (127 μm) draw-down blade. Next, the film was UV cured and characterized following the same procedures described in Example 1.

### Comparative Example 11: Epoxy Siloxane Nanocomposite Formulation

An epoxy siloxane oligomer (1.25 g) (PC-2003 from Polyset Co. Inc.) was mixed with 2.93 g of 3,4-epoxycyclohexylmethyl 3,4-epoxycyclohexanecarboxylate (Sigma Aldrich) and 7.28 g of the nanoparticle solution (70 wt % ˜25 nm solid spherical SiO₂ nanoparticles and 30 wt % methyl ethyl ketone from Admatechs, YA025C-MFK). The solution was sonicated repeatedly to ensure homogeneous mixing. After sonication, 0.3 g of the triarylsulfonium hexafluoroantimonate salts was added into the solution and mixed using Vortex. A 52 μm thick film was prepared on a 50 μm Melinex® 462 PET using a 8 mil (203 μm) draw-down blade. Next, the film was UV cured and characterized following the same procedures described in Example 1.

### Comparative Example 12: Epoxy Siloxane Nanocomposite Formulation

A formulation consisting of the components listed in the table was prepared. 4.18 g of an epoxy siloxane oligomer (PC-2003 from Polyset Co. Inc.) was mixed with 5.82 g of octaepoxycyclohexyldimethylsilyl POSS (EP0430 from Hybrid Plastics) and 4.0 g of methyl ethyl ketone. The solution was sonicated repeatedly to ensure homogeneous mixing. After sonication, 0.3 g of the triarylsulfonium hexafluoroantimonate salts was added into the solution and mixed using Vortex. A 52 μm thick film was prepared on a 50 μm Melinex® 462 PET using a 8 mil (203 μm) draw-down blade. Next, the film was UV cured and characterized following the same procedures described in Example 1.

1. A curable resin composition comprising:
(a) 27 to 60 wt % of a liquid siloxane oligomer comprising polymerized units of formula R¹ₘR²ₙSi(OR³)₄₋ₘ₋ₙ, wherein R¹ is a C₅-C₂₀ aliphatic group comprising an oxirane ring fused to an alicyclic ring, R² is a C₁-C₂₀ alkyl, C₆-C₃₀ aryl group, or a C₅-C₂₀ aliphatic group having one or more heteroatoms, R³ is a C₁-C₄ alkyl group or a C₁-C₄ acyl group, m is 0.1 to 2.0 and n is 0 to 2.0;
(b) 35 to 66 wt % non-porous nanoparticles of silica, a metal oxide, or a mixture thereof, the non-porous nanoparticles having an average particle diameter from 5 to 50 nm; and
(c) 0.5 to 7 wt % of a cationic photoinitiator.

2. The curable resin composition of claim 1 in which the non-porous nanoparticles have a surface area from 50 to 500 m²/g.

3. The curable resin composition of claim 2 in which R¹ contains 6 to 15 carbon atoms.

4. The curable resin composition of claim 3 in which when R² is alkyl it contains no more than 15 carbon atoms.

5. The curable resin composition of claim 4 in which R¹ comprises an oxirane ring fused to an alicyclic ring having 5 or 6 carbon atoms.

6. The curable resin composition of claim 5 in which m is from 0.8 to 1.5.

7. The curable resin composition of claim 6 in which n is no greater than 0.5.

8. The curable resin composition of claim 7 further comprising 1 to 20 wt % of a reactive modifier comprising at least two epoxycyclohexane groups or at least two oxetane rings.

9. The curable resin composition of claim 8 in which the nanoparticles have an average particle diameter from 10 to 40 nm.

10. The curable resin composition of claim 1 further comprising one or more core-shell rubber nanoparticles.

11. The curable resin composition of claim 10 wherein the one or more core-shell rubber nanoparticles are present in an amount of from 0.1 to 10 wt %.

12. A method for producing an optically transparent polymeric coating; said method comprising applying to a substrate a liquid curable resin composition comprising: (a) 27 to 60 wt % of a siloxane oligomer comprising polymerized units of formula R¹ₘR²ₙSi(OR³)₄₋ₘ₋ₙ, wherein R¹ is a C₅-C₂₀ aliphatic group comprising an oxirane ring fused to an alicyclic ring, R² is a C₁-C₂₀ alkyl, C₆-C₃₀ aryl group, or a C₅-C₂₀ aliphatic group having one or more heteroatoms, R³ is a C₁-C₄ alkyl group or a C₁-C₄ acyl group, m is 0.1 to 2.0 and n is 0 to 2.0; (b) 35 to 66 wt % non-porous nanoparticles of silica, a metal oxide, or a mixture thereof, the non-porous nanoparticles having an average particle diameter from 5 to 50 nm; and (c) 0.5 to 7 wt % of a cationic photoinitiator.
